(19) United States
(12) Patent Application Publication
(10) Pub. No.: US 2014/0153635 A1
(43) Pub. Date: Jun. 5, 2014

(54) METHOD, COMPUTER PROGRAM PRODUCT, AND SYSTEM FOR MULTI-THREADED VIDEO ENCODING

(71) Applicant: NVIDIA CORPORATION, Santa Clara, CA (US)

(72) Inventors: Guanjun Zhang, San Jose, CA (US); Haixia Shi, Sunnyvale, CA (US); Olivier Lapicque, San Jose, CA (US); Xiaohua Yang, San Jose, CA (US)

(73) Assignee: NVIDIA Corporation, Santa Clara, CA (US)

(21) Appl. No.: 13/706,302

(22) Filed: Dec. 5, 2012

(51) Int. Cl. H04N 7/26

(52) U.S. Cl. CPC H04N 7/26005
USPC 375/240.02

(57) ABSTRACT

A method, computer program product, and system are provided for multi-threaded video encoding. The method includes the steps of generating a set of motion vectors in a hardware video encoder based on a current frame of a video stream and a reference frame of the video stream, dividing the current frame into a number of slices, encoding each slice of the current frame based on the set of motion vectors, and combining the encoded slices to generate an encoded bitstream.

### FIELD OF THE INVENTION

The present invention relates to video encoding, and more particularly to hardware and software implementations of video encoders.

### BACKGROUND

Microsoft™ Windows Media Video (WMV) 9 (i.e., VC-1) is a standard that describes a motion compensation based video codec. The Society of Motion Picture and Television Engineers (SMPTE) 421M specification formally details the complete bitstream syntax of the VC-1 codec. The basic functionality of the VC-1 codec includes a block-based motion compensation and a spatial transform scheme similar to other video codecs such as MPEG-1 and H.261.

Traditional video encoders are implemented either entirely in software or entirely in hardware. Pure software based encoders are typically very slow and are unable to encode video data at high definition resolutions in real-time. On the other hand, hardware based implementations may be able to encode high definition video in real-time, but are usually limited to only a few specified video codecs (because each distinct video codec may require a different hardware architecture). While many systems may implement a hardware-based video encoder for one codec, such as H.264/MPEG-4 Part 10, the hardware-based video encoder is not configured to encode video compatible with other codecs. Thus, there is a need for addressing this issue and/or other issues associated with the prior art.

### SUMMARY

A method, computer program product, and system are provided for multi-threaded video encoding. The method includes the steps of generating a set of motion vectors in a hardware video encoder based on a current frame of a video stream and a reference frame of the video stream, dividing the current frame into a number of slices, encoding each slice of the current frame based on the set of motion vectors, and combining the encoded slices to generate an encoded bitstream.

### BRIEF DESCRIPTION OF THE DRAWINGS

FIG. 1 illustrates a flowchart of a method for generating an encoded video bitstream, in accordance with one embodiment;

FIG. 2 illustrates a flowchart of a method for generating an encoded VC-1 compatible bitstream, in accordance with one embodiment;

FIG. 3 illustrates a system for generating an encoded VC-1 compatible bitstream, in accordance with one embodiment;

FIG. 4A shows a conceptual diagram of the stages of the VC-1 codec implemented by system, in accordance with one embodiment;

FIG. 4B illustrates the VC-1 compatible bitstream of FIG. 4A, in accordance with one embodiment;

FIG. 5 illustrates a parallel processing unit (PPU), according to one embodiment;

FIG. 6 illustrates the streaming multi-processor of FIG. 5, according to one embodiment; and

FIG. 7 illustrates an exemplary system in which the various architecture and/or functionality of the various previous embodiments may be implemented.

### DETAILED DESCRIPTION

The basic functionality of the VC-1 codec includes a block-based motion compensation scheme similar to many other popular video codecs. Some of these video codecs are implemented, at least in part, in hardware-based video encoders that are capable of estimating motion vectors in real-time for high definition video at acceptable frame rates (e.g., 720 p at 30 fps). For example, hardware-based video encoders compatible with the H.264/MPEG-4 Part 10 (Advanced Video Coding) standard are implemented in readily available ASICs or as part of a System-on-Chip (SoC). These hardware video encoders typically include a motion estimation engine for generating a set of for a video frame motion vectors. One approach for adapting the hardware-based video encoder compatible with another video codec to generate a VC-1 compatible bitstream using a hardware and software hybrid architecture is presented.

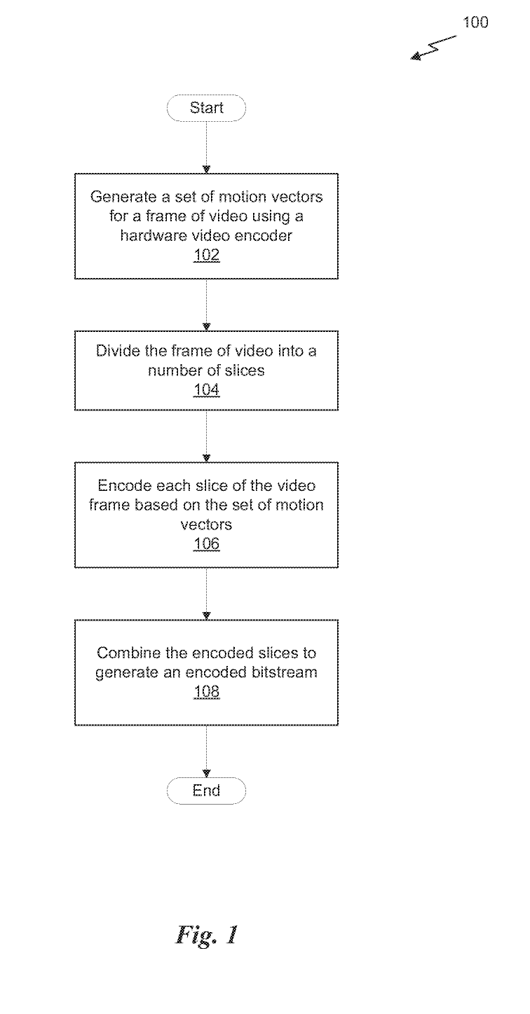

FIG. 1 illustrates a flowchart of a method 100 for generating an encoded video bitstream, in accordance with one embodiment. At step 102, a set of motion vectors for a frame of video is generated using, at least in part, a hardware video encoder. In one embodiment, the hardware video encoder is compatible with the H.264/MPEG-4 Part 10 standard. The hardware video encoder may include a motion estimation engine that analyzes a plurality of blocks of a video frame by comparing the plurality of blocks to one or more previous frames of the video in order to estimate a plurality of motion vectors for the plurality of blocks. At step 104, the frame of video is divided into a number of slices (i.e., portions). At step 106, each slice of the video frame is encoded based on the set of motion vectors. In one embodiment, each slice is encoded substantially in parallel. Then, at step 108, the encoded slices of the video frame are combined to generate the encoded bitstream. In one embodiment, the encoded bitstream is a VC-1 compatible bitstream.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

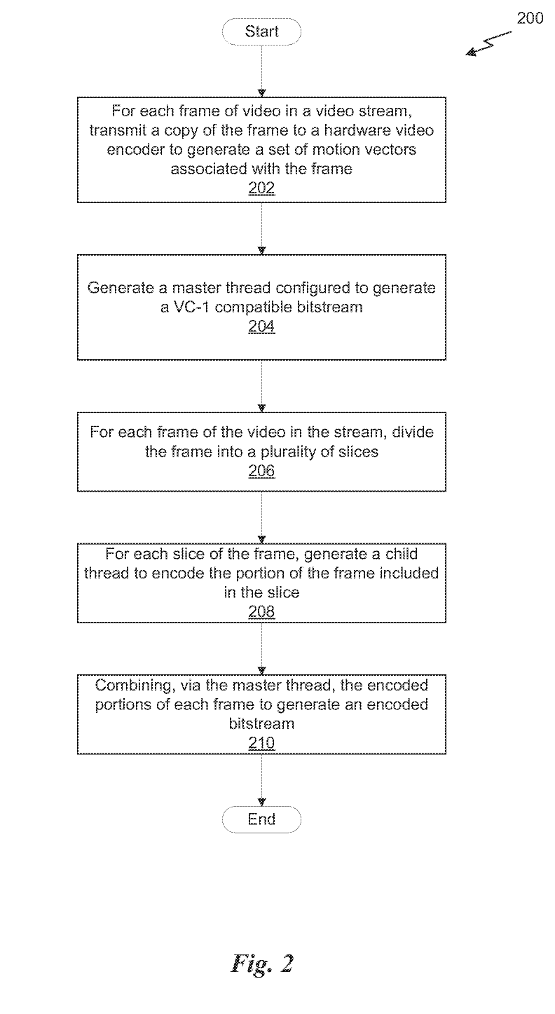

FIG. 2 illustrates a flowchart of a method 200 for generating an encoded VC-1 compatible bitstream, in accordance with one embodiment. At step 202, for each frame of video in a video stream, a copy of the frame is transmitted to a hardware video encoder to generate a set of motion vectors associated with a plurality of macroblocks in the frame. In one embodiment, the hardware video encoder is implemented in an ASIC (application specific integrated circuit). In another embodiment, the hardware video encoder is implemented in an FPGA (field programmable gate array). In yet another embodiment, the hardware video encoder is implemented as a logic block in a SoC.

The hardware video encoder may be compatible with the H.264/MPEG-4 Part 10 standard or some other video codec (e.g., MPEG-2) that implements a motion compensation component. The hardware video encoder includes a motion estimation engine that populates a surface (e.g., a buffer in memory associated with the frame) with motion vector information for the frame. In one embodiment, each macroblock may be associated with one or more motion vectors. The hardware video encoder may be configured to select whether the macroblock is associated with a single motion vector (i.e., each 16×16 block of pixels is associated with a different 16×16 block of pixels) or whether the macroblock is divided into a series of smaller blocks, each of the blocks being associated with a separate motion vector.

An encoded video stream encodes a plurality of video frames as a group of pictures (GOP), which includes at least one key frame (i.e., an I-frame) that is intra-coded and one or more predicted frames (P-frames and B-frames) that are inter-coded based on one or more reference frames. I-frames are encoded based on information included within that frame only (e.g., transforming each of the macroblocks in the frame based on a discrete cosine transform (DCT), quantizing the transformed macroblocks, and entropy encoding the transformed macroblocks to generate an encoded I-frame). P-frames are video frames which are encoded based on motion vectors associated with a preceding reference frame, which is typically an earlier I-frame. B-frames are video frames which are encoded based on motion vectors associated with either an earlier or later reference frame (I-frame or P-frame). The GOP may have a structure such as IBBBPBBBPBBBPBBB, which repeats for each subsequent GOP in the video stream.

For an inter-coded frame, the hardware video encoder buffers a plurality of frames preceding and subsequent to the inter-coded frame. One or more of the buffered frames may be selected as reference frames for a particular macroblock in the inter-coded frame. Each block of pixels in the inter-coded frame is compared to one or more of the reference frames to determine a corresponding block of pixels in the reference frame that closely matches the block of pixels in the inter-coded frame. The difference between the location of the block of pixels in the inter-coded frame and the location of the corresponding block of pixels in the reference frame is represented by a motion vector. In one embodiment, the hardware video encoder generates one motion vector for each 16×16 block of pixels in the inter-coded frame. In another embodiment, the hardware video encoder may implement variable block-size motion compensation (VBSMC) algorithms that supports different block sizes of 16×16, 16×8, 8×16, 8×8, 8×4, 4×8, and 4×4 blocks of pixels. Each macroblock may be associated with one or more variable-sized blocks. For example, in VC-1, a sequence of frames in the YUV colorspace is encoded with each macroblock being associated with four 8×8 blocks of coded samples for the luma channel (i.e., Y) and one 8×8 block of coded samples for each chroma channel (i.e., U, V). The chroma channel is subsampled at ½ horizontal resolution and vertical resolution (i.e., there is one chroma sample per every four luma samples). Each of the 8×8 blocks may be further sub-divided into 8×4, 4×8, or 4×4 blocks of pixels.

At step 204, a master thread is generated to generate a VC-1 compatible bitstream. In one embodiment, the master thread is executed by a graphics processing unit. At step 206, the master thread divides the frame of video into a plurality of slices (i.e., portions). In one embodiment, the number of slices may be configured based on the number of system resources such as processor cores. In another embodiment, the number of slices may be configured dynamically based on the compression time for a previous frame. At step 208, for each slice of the frame, a number of child threads are generated to encode the portion of the frame associated with the slice. In one embodiment, the frame is divided into N slices, each slice comprising a number of rows of the frame. For example, if N equals 2, then a first child thread is allocated to a first half (i.e., a top half) of the rows of a frame and a second child thread is allocated to a second half (i.e., a bottom half) of the rows of the frame. At step 210, for each frame of video in the stream, the master thread combines the encoded slices generated by each of the child threads associated with the frame to generate an encoded VC-1 compatible bitstream.

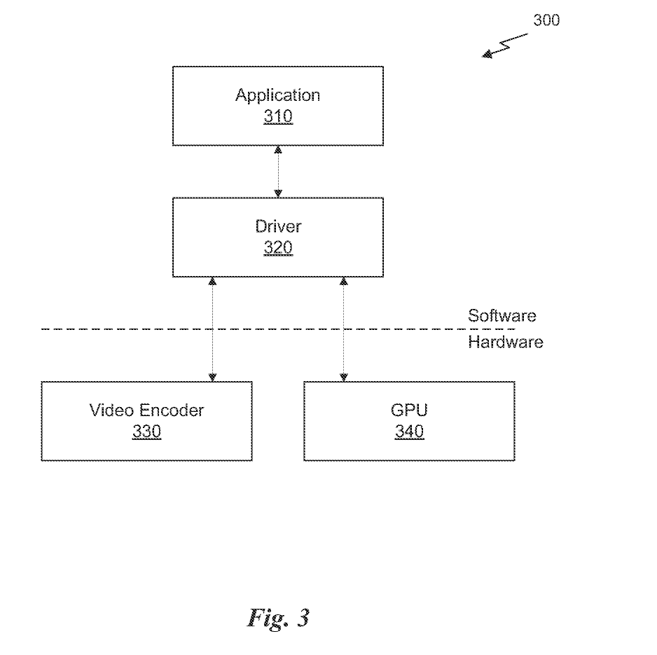

FIG. 3 illustrates a system 300 for generating an encoded VC-1 compatible bitstream, in accordance with one embodiment. An application 310 and driver 320 are executed on a central processing unit (CPU) (not shown). The application 310 may be configured to open a stream of video data and process the stream to generate an encoded VC-1 compatible bitstream. The application 310 issues one or more instructions to the driver 320 that cause the driver 320 to configure the video encoder 330 to generate a set of motion vectors for each frame of video in the stream. The video encoder 330 buffers one or more frames of video data in the hardware to generate the set of motion vectors. In one embodiment, the video encoder 330 buffers three or more frames of video data, including at least but not limited to a current frame associated with the set of motion vectors to be generated, a previous reference frame representing a frame corresponding to an earlier point in time in the stream than the time associated with the current frame, and a next reference frame representing a frame corresponding to a later point in time in the stream than the time associated with the current frame. For some of frames in the stream, including the first frame in the sequence, the frames may be intra-coded, and motion vectors associated with a different reference frame are not generated for those frames. For other frames in the stream, the frames are encoded based on either the previous reference frame, the next reference frame, both the previous reference frame and the next reference frame, or the previous reference frame, the next reference frame, and one or more additional reference frames.

In one embodiment, the video encoder 330 is configured to generate one or more motion vector buffers in memory for each frame of video and return a pointer to the motion vector buffers to the driver 320. Each motion vector buffer includes a plurality of motion vectors according to a specified format. In one embodiment, the motion vector buffer includes six motion vectors (4 luma motion vectors and 2 chroma motion vectors) per macroblock of the frame. In another embodiment, the motion vector buffer may include a different number of motion vectors (e.g., the luma motion vectors may be associated with 4×4 pixel blocks within the macroblock). In yet other embodiments, the number of motion vectors per macroblock may be decided dynamically by the video encoder 330. In other words, the video encoder 330 may perform motion vector estimation for different sized macroblocks and select the size macroblocks that result in the smallest amount of error between the source frame and a regenerated frame based on the encoded motion vectors.

Once the video encoder 330 has generated the motion vector buffer for a frame of video, the video encoder 330 notifies the driver that the motion vector buffer is ready. The video encoder 330 may transmit a pointer to the motion vector buffer to the driver 320. The driver 320 may issue instructions that cause the threads to be generated for execution by the graphics processing unit (GPU) 340. The driver 320 generates a master thread that includes a plurality of instructions for generating a VC-1 compatible bitstream for the frame based on the motion vector buffer.

In an alternate embodiment, the driver 320 may generate the master thread substantially simultaneously with the video encoder 330 generating the motion vector buffer. The master thread will stall until the motion vector buffer for the frame is available. In such an alternate embodiment, the video encoder 330 may notify the master thread when the motion vector buffer is available rather than the driver 320. For example, the master thread may be generated prior to the frame being transmitted to the video encoder 330. The master thread may perform optional processing on the frame such as by converting the frame from one color space (e.g., RGB) to another color space (e.g., YUV). Other types of image processing may be done prior to the frame being transmitted to the video encoder 330, such as applying an image filter such as a Gaussian blur, a bilateral filter, or some other type of image filter known to those of skill in the art.

In one embodiment, the driver 320 is configured to generate a plurality of child threads to encode different slices (i.e., portions) of the frame in parallel. A slice of the frame is allocated to each of the child threads, which encodes the corresponding slice of the frame allocated to that child thread. Once all of the child threads have encoded the slices for the frame, the master thread is configured to combine the encoded slices from each of the child threads to generate the VC-1 compatible bitstream. In some embodiments, the master thread is capable of generating a number N of child threads from the GPU 340, without the intervention of the driver 320. In such embodiments, the master thread may be configured to determine an optimal number of slices for a frame in order to efficiently encode the frame. For example, the master thread could track the time for each frame to be encoded and change the number N of child threads spawned for the next frame based on the time required to encode one or more previous frames.

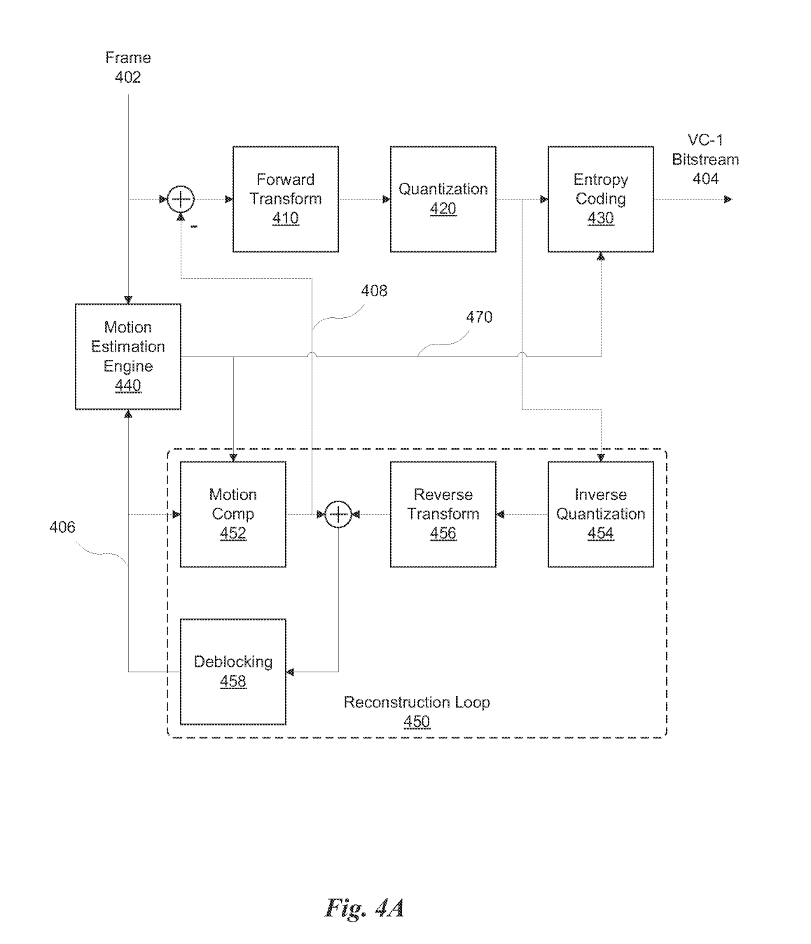

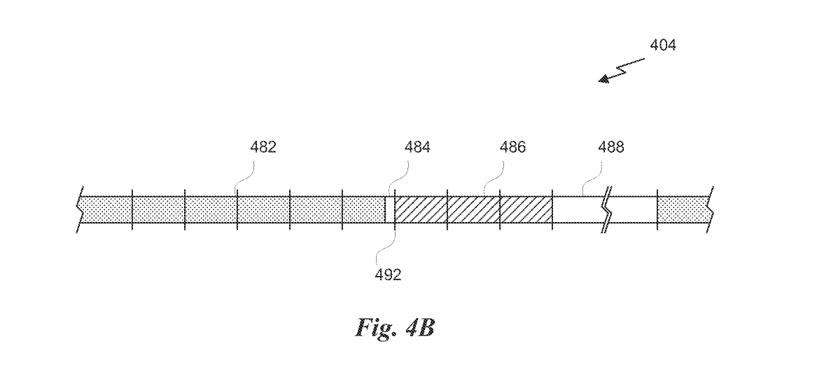

FIG. 4A shows a conceptual diagram of the stages of the VC-1 codec implemented by system 300, in accordance with one embodiment. As shown in FIG. 4A, a frame 402 from a video stream is input to a motion estimation engine 440. The motion estimation engine 440 may be implemented as part of the hardware video encoder 330, described above. The motion estimation engine 440 generates a set of motion vectors 470 associated with the current frame 402, which are output to later stages of the VC-1 codec; i.e., entropy coding 430 and motion compensation 452. The motion vectors 470 indicate a displacement (i.e., a two-component vector) of a block of the current frame 402 to a corresponding block in a reference frame. The motion estimation engine 440 may be configured at pixel accuracy (i.e., motion vectors are specified in increments of pixel width or height) or sub-pixel accuracy (i.e., motion vectors may be specified in increments less than the pixel width or height such as ¼ a pixel width and ¼ a pixel height). In motion estimation engines 440 that are configured with sub-pixel accuracy, the motion estimation engine 440 may interpolate values at sub-pixel accuracy by interpolating values between pixels in the reference frame. In one embodiment, the motion estimation engine 440 generates the set of motion vectors 470 from a reconstructed frame 406 generated by a reconstruction loop 450, discussed in more detail below. In other embodiments, the reconstruction loop 450 may not be included in the implementation of the VC-1 codec. In such other embodiments, the motion estimation engine 440 generates the set of motion vectors 470 from a buffered version of the previous frame.

Once the set of motion vectors 470 have been generated by the motion estimation engine 440, a residual error is calculated by taking the difference between the current frame 402 and a motion-compensated predicted frame 408. The motion-compensated predicted frame 408 is generated by reconstructing the previous frame and transforming the reconstructed frame based on the set of motion vectors 470 associated with the current frame 402. In some embodiments that do not implement the reconstruction loop 450, the motion-compensated predicted frame 408 is generated by applying the set of motion vectors 470 associated with the current frame 402 to the buffered previous frame.

A forward transform engine 410 receives the residual error and applies a linear, energy-compacting transform to the residual error. The residual error for each macroblock is a matrix that indicates the difference of the macroblock in the current frame 402 and a corresponding macroblock in the motion-compensated predicted frame 408 (i.e., the difference in luminance values or chrominance values in the Y, U, or V channels of the current frame 402). The forward transform engine 410 applies a matrix multiplication operation to each block of the macroblock (i.e., 8×8, 4×8, 8×4, or 4×4 transforms) to generate a matrix of coefficients. The generated transform coefficients are then quantized in the quantization engine 420. The quantization engine 420 may quantize the transform coefficients for each block by rearranging the transform coefficients into a one-dimensional array and then scaling each transform coefficient in the one-dimensional array according to the quantization method. The quantization engine 420 may be configured to use a dead zone quantization method, where transform coefficients below a threshold value are quantized to zero and all other coefficients above the threshold value are quantized based on a number of uniform quantization regions, or a uniform quantization method, where all transform coefficients are quantized based on uniform quantization regions.

The quantized transform coefficients are then transmitted to an entropy coding engine 430 that generates the VC-1 compatible bitstream 404 for the current frame 402. The entropy coding engine 430 may utilize tables of variable length codes to encode the various symbols to generate the VC-1 compatible bitstream 404. The VC-1 compatible bitstream 404 includes variable length codes for the quantized transform coefficients and the set of motion vectors 470 as well as other information such as the resolution of block size chosen for the frame or macroblocks, a skip macroblock bitplane, and a frame/field switch bitplane.

In one embodiment, the forward transform engine 410, the quantization engine 420, and the entropy encoding engine 430 are implemented per slice of the current frame 402 in parallel. The master thread receives the set of motion vectors from the motion estimation engine 440 implemented in the hardware video encoder 330 and calculates the residual error for the current frame 402 in a memory. A child thread is generated for each slice of the current frame 402. In one embodiment, the master thread generates a separate copy of the residual error for the current frame 402 for each child thread (i.e., slice of the current frame 402). Each child thread implements the forward transform engine 410, the quantization engine 420, and the entropy coding engine 430, generating a VC-1 compatible bitstream for each slice of the current frame 402. Then, the master thread combines the VC-1 compatible bitstreams for the plurality of slices to generate a VC-1 compatible bitstream 404 for the current frame 402. The VC-1 compatible bitstream 404 for the current frame 402 may be combined with VC-1 compatible bitstreams for additional frames of the video stream to generate a VC-1 compatible bitstream for the raw video stream. In one embodiment, the master thread may remove some redundant bits from each of the VC-1 compatible bitstreams for each slice before the bitstreams are combined in order to ensure that the VC-1 compatible bitstream 404 for the current frame 402 is compatible with the VC_{—}1 specification. The redundant bits may be generated by the child threads in response to overlapped macroblock rows and/or a special escape mode that includes three starting point symbols in the VC-1 compatible bitstreams for the slices. In another embodiment, the child threads may implement the forward transform engine 410 and the quantization engine 420, while the master thread implements the entropy encoding engine 430 to generate the VC-1 compatible bitstream 404 for the current frame.

In one embodiment, the VC-1 codec is implemented with a reconstruction loop 450. The reconstruction loop 450 includes an inverse quantization engine 454 and a reverse transform engine 456. The inverse quantization engine 454 receives the quantized transform coefficients from the quantization engine 420 and normalizes the quantized transform coefficients to generate a reconstructed set of transform coefficients that are transmitted to the reverse transform engine 456. The reverse transform engine 456 receives the reconstructed transform coefficients and generates a reconstructed residual error. The reconstructed residual error represents a decoded version of the residual error received by the forward transform engine 410. The reconstructed residual error is combined with the motion-compensated predicted frame 408 and transmitted to the deblocking engine 458. The deblocking engine 458 implements a filter to reduce artifacts introduced by the encoding/decoding process. In one embodiment, the filter is implemented to smooth out discontinuities at block boundaries, such as every 4^{th}, 8^{th}, or 16^{th} pixel. The filter may combine pixel values from one or more pixels on both sides of the block boundary to reduce the artifacts introduced by the block-based motion estimation scheme. The deblocking engine 458 generates the reconstructed frame 406. It will be appreciated that the deblocking engine 458 may perform filter operations across slice boundaries. Therefore, the residual error for all slices must be combined with the motion compensated predicted frame 408 to generate a full reconstructed frame 406 for use as a reference frame. In one embodiment, each child thread may implement a reconstruction loop 450 for the slice allocated to the child thread. Once the child thread has combined the residual error with a portion of the motion-compensated predicted frame 408 for the slice, the result is transmitted to a deblocking engine 458 implemented in the master thread. The master thread then applies the filter to the result for the entire reconstructed frame 406.

FIG. 4B illustrates the VC-1 compatible bitstream 404 of FIG. 4A, in accordance with one embodiment. As shown in FIG. 4B, the VC-1 compatible bitstream 404 is a serial bitstream that includes a plurality of variable length codes 482 for a corresponding plurality of symbols that represent the motion vectors and quantized transform coefficients for the encoded frames of the video stream. Only a small portion of the bitstream 404 is shown in FIG. 4B. Because the variable length codes 482 used to encode the symbols are not configured to be byte aligned, the variable length codes 482 for a particular slice may end in between two byte boundaries 492. Each child thread generates a portion of the VC-1 compatible bitstream 404 associated with a slice of the current frame 402. In order to delineate between slice boundaries in the VC-1 compatible bitstream 404, the child threads may be configured to add stuffing bits 484 to the end of the portion of the bitstream (e.g., variable length codes 482) associated with each slice. In other words, each child thread generates a portion of the bitstream that is byte aligned and then the master thread concatenates these portions of the bitstream to generate the VC-1 compatible bitstream 404.

The VC-1 specification includes SYNCMARKERS 486, which, as defined in the VC-1 specification, are 24-bit symbols that are byte-aligned and may be used to indicate boundaries at the start of a macroblock row. In one embodiment, the child threads may be configured to add one or more stuffing bits 484 (i.e., ‘0’) to the end of the corresponding portion of the bitstream generated by the child thread. Then, the child thread may be configured to add a SYNCMARKER 486 after the stuffing bits 484 to indicate a slice boundary in the generated VC-1 compatible bitstream 404. Alternately, the master thread could be configured to add the SYNCMARKER 486 when the master thread combines the portions of the bitstream generated by each child thread. The SYNCMARKERS 486 may be followed by a payload 488 that optionally may include additional information about the video stream. In one embodiment, the payload 488 may be 5 bytes or 11 bytes long. Following the payload 488, the master thread may concatenate the variable length codes 482 for the next slice.

It will be appreciated that the framework set forth above may be implemented in a multi-threaded architecture, such as a CPU that is configured to execute a plurality of threads using time slicing techniques. In one embodiment, the encoding process may be implemented using a highly parallel architecture such as a graphics processing unit that is configured to execute tens or hundreds of threads in parallel. The following description illustrates one such architecture that could be used to implement at least a portion of the framework set forth above.

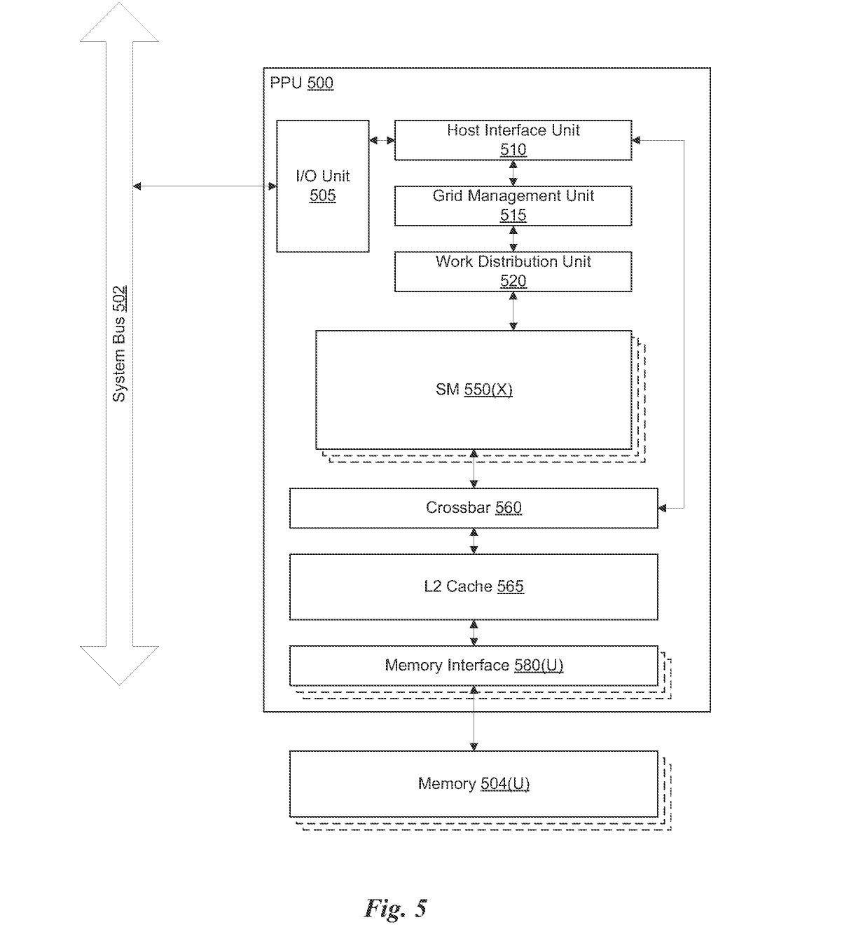

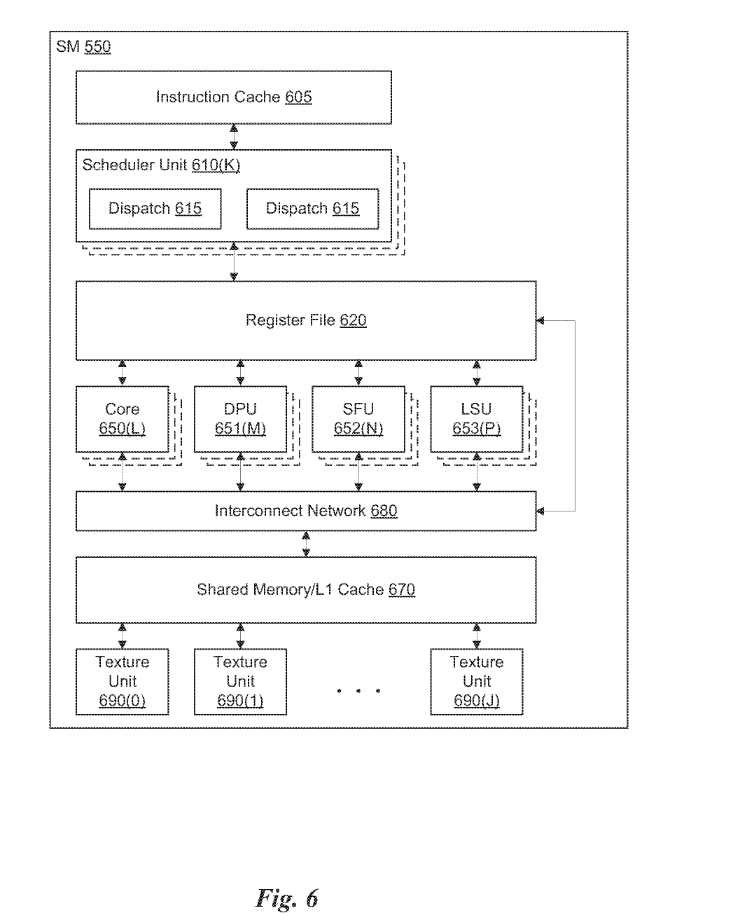

FIG. 5 illustrates a parallel processing unit (PPU) 500, according to one embodiment. While a parallel processor is provided herein as an example of the PPU 500, it should be strongly noted that such processor is set forth for illustrative purposes only, and any processor may be employed to supplement and/or substitute for the same. In one embodiment, the PPU 500 is configured to execute a plurality of threads concurrently in two or more streaming multi-processors (SMs) 550. A thread (i.e., a thread of execution) is an instantiation of a set of instructions executing within a particular SM 550. Each SM 550, described below in more detail in conjunction with FIG. 6, may include, but is not limited to, one or more processing cores, one or more load/store units (LSUs), a level-one (L1) cache, shared memory, and the like.

In one embodiment, the PPU 500 includes an input/output (I/O) unit 505 configured to transmit and receive communications (i.e., commands, data, etc.) from a central processing unit (CPU) (not shown) over the system bus 502. The I/O unit 505 may implement a Peripheral Component Interconnect Express (PCIe) interface for communications over a PCIe bus. In alternative embodiments, the I/O unit 505 may implement other types of well-known bus interfaces.

The PPU 500 also includes a host interface unit 510 that decodes the commands and transmits the commands to the grid management unit 515 or other units of the PPU 500 (e.g., memory interface 580) as the commands may specify. The host interface unit 510 is configured to route communications between and among the various logical units of the PPU 500.

In one embodiment, a program encoded as a command stream is written to a buffer by the CPU. The buffer is a region in memory, e.g., memory 504 or system memory, that is accessible (i.e., read/write) by both the CPU and the PPU 500. The CPU writes the command stream to the buffer and then transmits a pointer to the start of the command stream to the PPU 500. The host interface unit 510 provides the grid management unit (GMU) 515 with pointers to one or more streams. The GMU 515 selects one or more streams and is configured to organize the selected streams as a pool of pending grids. The pool of pending grids may include new grids that have not yet been selected for execution and grids that have been partially executed and have been suspended.

A work distribution unit 520 that is coupled between the GMU 515 and the SMs 550 manages a pool of active grids, selecting and dispatching active grids for execution by the SMs 550. Pending grids are transferred to the active grid pool by the GMU 515 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 520. In addition to receiving grids from the host interface unit 510 and the work distribution unit 520, the GMU 510 also receives grids that are dynamically generated by the SMs 550 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 500. An application may include instructions (i.e., API calls) that cause the driver kernel to generate one or more grids for execution. In one embodiment, the PPU 500 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 500 comprises X SMs 550(X). For example, the PPU 100 may include 15 distinct SMs 550. Each SM 550 is multi-threaded and configured to execute a plurality of threads (e.g., 32 threads) from a particular thread block concurrently. Each of the SMs 550 is connected to a level-two (L2) cache 565 via a crossbar 560 (or other type of interconnect network). The L2 cache 565 is connected to one or more memory interfaces 580. Memory interfaces 580 implement 16, 32, 64, 128-bit data buses, or the like, for high-speed data transfer. In one embodiment, the PPU 500 comprises U memory interfaces 580(U), where each memory interface 580(U) is connected to a corresponding memory device 504(U). For example, PPU 500 may be connected to up to 6 memory devices 504, such as graphics double-data-rate, version 5, synchronous dynamic random access memory (GDDR5 SDRAM).

In one embodiment, the PPU 500 implements a multi-level memory hierarchy. The memory 504 is located off-chip in SDRAM coupled to the PPU 500. Data from the memory 504 may be fetched and stored in the L2 cache 565, which is located on-chip and is shared between the various SMs 550. In one embodiment, each of the SMs 550 also implements an L1 cache. The L1 cache is private memory that is dedicated to a particular SM 550. Each of the L1 caches is coupled to the shared L2 cache 565. Data from the L2 cache 565 may be fetched and stored in each of the L1 caches for processing in the functional units of the SMs 550.

In one embodiment, the PPU 500 comprises a graphics processing unit (GPU), such as the GPU 340. The PPU 500 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 500 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the GMU 515 may configure one or more SMs 550 to execute a vertex shader program that processes a number of vertices defined by the model data. In one embodiment, the GMU 515 may configure different SMs 550 to execute different shader programs concurrently. For example, a first subset of SMs 550 may be configured to execute a vertex shader program while a second subset of SMs 550 may be configured to execute a pixel shader program. The first subset of SMs 550 processes vertex data to produce processed vertex data and writes the processed vertex data to the L2 cache 565 and/or the memory 504. After the processed vertex data is rasterized (i.e., transformed from three-dimensional data into two-dimensional data in screen space) to produce fragment data, the second subset of SMs 550 executes a pixel shader to produce processed fragment data, which is then blended with other processed fragment data and written to the frame buffer in memory 504. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 500 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 500 is embodied on a single semiconductor substrate. In another embodiment, the PPU 500 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 500 may be included on a graphics card that includes one or more memory devices 504 such as GDDR5 SDRAM. The graphics card may be configured to interface with a PCIe slot on a motherboard of a desktop computer that includes, e.g., a northbridge chipset and a southbridge chipset. In yet another embodiment, the PPU 500 may be an integrated graphics processing unit (iGPU) included in the chipset (i.e., Northbridge) of the motherboard.

It will be appreciated that a master thread may be configured to execute on a first SM 550(0) of PPU 500. In addition, two or more child threads may be configured to execute on two or more additional SMs (e.g., 150(1), 550(2), etc.). The master thread and child threads may access motion vector data stored in a memory by a hardware video encoder 330.

FIG. 6 illustrates the streaming multi-processor 550 of FIG. 5, according to one embodiment. As shown in FIG. 6, the SM 550 includes an instruction cache 605, one or more scheduler units 610, a register file 620, one or more processing cores 650, one or more double precision units (DPUs) 651, one or more special function units (SFUs) 652, one or more load/store units (LSUs) 653, an interconnect network 680, a shared memory/L1 cache 670, and one or more texture units 690.

As described above, the work distribution unit 520 dispatches active grids for execution on one or more SMs 550 of the PPU 500. The scheduler unit 610 receives the grids from the work distribution unit 520 and manages instruction scheduling for one or more thread blocks of each active grid. The scheduler unit 610 schedules threads for execution in groups of parallel threads, where each group is called a warp. In one embodiment, each warp includes 32 threads. The scheduler unit 610 may manage a plurality of different thread blocks, allocating the thread blocks to warps for execution and then scheduling instructions from the plurality of different warps on the various functional units (i.e., cores 650, DPUs 651, SFUs 652, and LSUs 653) during each clock cycle.

In one embodiment, each scheduler unit 610 includes one or more instruction dispatch units 615. Each dispatch unit 615 is configured to transmit instructions to one or more of the functional units. In the embodiment shown in FIG. 6, the scheduler unit 610 includes two dispatch units 615 that enable two different instructions from the same warp to be dispatched during each clock cycle. In alternative embodiments, each scheduler unit 610 may include a single dispatch unit 615 or additional dispatch units 615.

Each SM 550 includes a register file 620 that provides a set of registers for the functional units of the SM 550. In one embodiment, the register file 620 is divided between each of the functional units such that each functional unit is allocated a dedicated portion of the register file 620. In another embodiment, the register file 620 is divided between the different warps being executed by the SM 550. The register file 620 provides temporary storage for operands connected to the data paths of the functional units.

Each SM 550 comprises L processing cores 650. In one embodiment, the SM 550 includes a large number (e.g., 192, etc.) of distinct processing cores 650. Each core 650 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 550 also comprises M DPUs 651 that implement double-precision floating point arithmetic, N SFUs 652 that perform special functions (e.g., copy rectangle, pixel blending operations, and the like), and P LSUs 653 that implement load and store operations between the shared memory/L1 cache 670 and the register file 620. In one embodiment, the SM 550 includes 64 DPUs 651, 32 SFUs 652, and 32 LSUs 653.

Each SM 550 includes an interconnect network 680 that connects each of the functional units to the register file 620 and the shared memory/L1 cache 670. In one embodiment, the interconnect network 680 is a crossbar that can be configured to connect any of the functional units to any of the registers in the register file 620 or the memory locations in shared memory/L1 cache 670.

In one embodiment, the SM 550 is implemented within a GPU. In such an embodiment, the SM 550 comprises J texture units 690. The texture units 690 are configured to load texture maps (i.e., a 2D array of texels) from the memory 504 and sample the texture maps to produce sampled texture values for use in shader programs. The texture units 690 implement texture operations such as anti-aliasing operations using mip-maps (i.e., texture maps of varying levels of detail). In one embodiment, the SM 550 includes 16 texture units 690.

The PPU 500 described above may be configured to perform highly parallel computations much faster than conventional CPUs. Parallel computing has advantages in graphics processing, data compression, biometrics, stream processing algorithms, and the like.

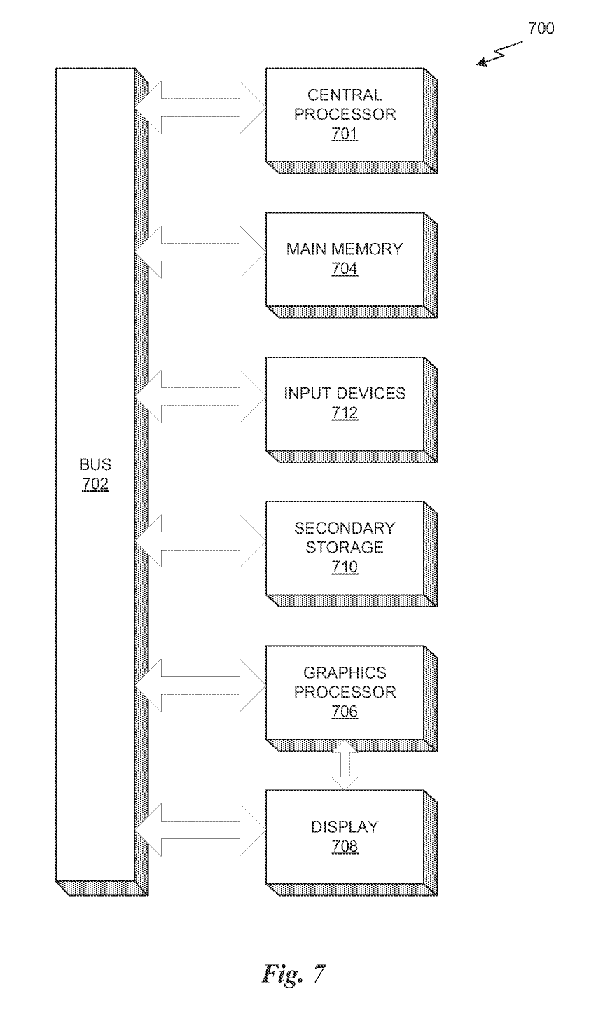

FIG. 7 illustrates an exemplary system 700 in which the various architecture and/or functionality of the various previous embodiments may be implemented. As shown, a system 700 is provided including at least one central processor 701 that is connected to a communication bus 702. The communication bus 702 may be implemented using any suitable protocol, such as PCI (Peripheral Component Interconnect), PCI-Express, AGP (Accelerated Graphics Port), HyperTransport, or any other bus or point-to-point communication protocol(s). The system 700 also includes a main memory 704. Control logic (software) and data are stored in the main memory 704 which may take the form of random access memory (RAM).

The system 700 also includes input devices 712, a graphics processor 706, and a display 708, i.e. a conventional CRT (cathode ray tube), LCD (liquid crystal display), LED (light emitting diode), plasma display or the like. User input may be received from the input devices 712, e.g., keyboard, mouse, touchpad, microphone, and the like. In one embodiment, the graphics processor 706 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710. The secondary storage 910 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 704 and/or the secondary storage 710. Such computer programs, when executed, enable the system 700 to perform various functions. The memory 704, the storage 710, and/or any other storage are possible examples of computer-readable media.

In one embodiment, the architecture and/or functionality of the various previous figures may be implemented in the context of the central processor 701, the graphics processor 706, an integrated circuit (not shown) that is capable of at least a portion of the capabilities of both the central processor 701 and the graphics processor 706, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, laptop computer, server, workstation, game consoles, embedded system, and/or any other type of logic. Still yet, the system 700 may take the form of various other devices including, but not limited to a personal digital assistant (PDA) device, a mobile phone device, a television, etc.

Further, while not shown, the system 700 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
generating a set of motion vectors in a hardware video encoder based on a current frame of a video stream and a reference frame of the video stream;
dividing the current frame into a number of slices;
encoding each slice of the current frame based on the set of motion vectors; and
combining the encoded slices to generate an encoded bitstream.

2. The method of claim 1, wherein the encoded bitstream is a VC-1 compatible bitstream.

3. The method of claim 1, further comprising:
generating a master thread configured to combine the encoded slices; and
generating two or more child threads, wherein each child thread is configured to encode a particular slice of the current frame allocated to the child thread.

4. The method of claim 3, wherein the master thread and the two or more child threads are configured to be executed in a parallel processing unit.

5. The method of claim 4, wherein the hardware video encoder and the parallel processing unit are included in a system-on-chip (SoC).

6. The method of claim 3, wherein each child thread of the two or more child threads is configured to generate a byte-aligned encoded slice by encoding motion vectors and quantized transform coefficients using variable length codes to generate a portion of the encoded bitstream.

7. The method of claim 6, wherein each child thread of the two or more child threads is configured to add one or more stuffing bits to the portion of the encoded bitstream generated by that child thread such that the portion is byte-aligned.

8. The method of claim 1, further comprising transmitting a copy of the current frame to the hardware video encoder.

9. The method of claim 8, wherein a driver receives instructions from an application and is configured to transmit the copy of the current frame to the hardware video encoder.

10. The method of claim 9, wherein the hardware video encoder notifies the driver that the set of motion vectors is available, and wherein the driver is configured to generate one or more threads for execution by a parallel processing unit to encode each slice of the current frame based on the set of motion vectors and combine the encoded slices to generate the encoded bitstream.

11. The method of claim 1, wherein the hardware video encoder is configured to implement an H.264/MPEG Part 10 (Advanced Video Coding) standard for video compression.

12. The method of claim 11, wherein the hardware video encoder includes a motion estimation engine that is configured to generate the set of motion vectors.

13. The method of claim 1, wherein the hardware video encoder is configured to implement an MPEG-2 standard for video compression.

14. A non-transitory computer-readable storage medium storing instructions that, when executed by a processor, cause the processor to perform steps comprising:
generating a set of motion vectors in a hardware video encoder based on a current frame of a video stream and a reference frame of the video stream;
dividing the current frame into a number of slices;
encoding each slice of the current frame based on the set of motion vectors; and
combining the encoded slices to generate an encoded bitstream

15. The non-transitory computer-readable storage medium of claim 14, wherein the encoded bitstream is a VC-1 compatible bitstream.

16. The non-transitory computer-readable storage medium of claim 14, the steps further comprising:
generating a master thread configured to combine the encoded slices; and
generating two or more child threads, wherein each child thread is configured to encode a particular slice of the current frame allocated to the child thread.

17. A system comprising:
a hardware video encoder configured to generate a set of motion vectors based on a current frame of a video stream and a reference frame of the video stream; and
a processor coupled to the hardware video encoder and configured to:
divide the current frame into a number of slices,
encode each slice of the current frame based on the set of motion vectors, and
combine the encoded slices to generate an encoded bitstream.

18. The system of claim 17, wherein the encoded bitstream is a VC-1 compatible bitstream.

19. The system of claim 17, wherein the hardware video encoder is configured to implement an H.264/MPEG Part 10 (Advanced Video Coding) standard for video compression

20. The system of claim 17, wherein the processor is a graphics processing unit, and wherein the processor is further configured to execute a master thread configured to combine the encoded slices and two or more child threads, wherein each child thread is configured to encode a particular slice of the current frame allocated to the child thread.
